(19) United States
(12) Patent Application Publication
(10) Pub. No.: US 2025/0031037 A1
(43) Pub. Date: Jan. 23, 2025

(54) USER AUTHENTICATION EXPOSURE

(71) Applicant: Nokia Technologies Oy, Espoo (FI)

(72) Inventors: Saurabh KHARE, Bangalore (IN); Chaitanya AGGARWAL, Munich (DE)

(21) Appl. No.: 18/779,223

(22) Filed: Jul. 22, 2024

(30) Foreign Application Priority Data
Jul. 23, 2023 (IN) 202311049493

(51) Int. Cl. H04W 12/065; H04W 12/69

(52) U.S. Cl. CPC H04W 12/065; H04W 12/69

(57) ABSTRACT

There is provided an apparatus (200, 300) comprising: means for transmitting a registration message, to an access and mobility management function, indicating whether the apparatus supports user authentication information sharing; means for receiving a request, from the access and mobility management function, requesting the apparatus to authenticate a user of the apparatus; means for authenticating the user based on the request; means for generating user authentication data; and means for transmitting the user authentication data to the access and mobility management function.

### FIELD

The present application relates to a method, apparatus, and computer program and in particular but not exclusively to user authentication exposure.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

A feature of modern communication systems is known as user authentication. A 5G system may support mechanisms to expose to third parties a result of a user equipment (UE) authenticating a user.

### SUMMARY

According to a first aspect there is disclosed an apparatus comprising: means for transmitting a registration message, to an access and mobility management function, indicating whether the apparatus supports user authentication information sharing; means for receiving a request, from the access and mobility management function, requesting the apparatus to authenticate a user of the apparatus; means for authenticating the user based on the request; means for generating user authentication data; and means for transmitting the user authentication data to the access and mobility management function.

According to some examples, the apparatus comprises means for enabling the user to register identification information in the apparatus, for each user of the apparatus.

According to some examples, the apparatus comprises means for assigning a username and at least one of a profile identification and a PIN identification to the identification information of each user.

According to some examples, the apparatus comprises means for transmitting the username and at least one of the profile identification and PIN identification for each user of the apparatus to a unified data management node, via the access and mobility management function.

According to some examples, the apparatus comprises means for authenticating the user by prompting the user to provide the user's identification information.

According to some examples, the identification information comprises at least one of: face biometric information; finger recognition information; PIN information.

According to some examples, the user authentication data comprises at least one of: authentication type; authentication result; profile identification; PIN identification.

According to some examples, the apparatus transmits user authentication data periodically.

According to a second aspect there is provided an apparatus comprising at least one processor; and at least one memory storing instructions that, when executed by the at least one processor, cause the apparatus at least to perform: transmitting a registration message, to an access and mobility management function, indicating whether the apparatus supports user authentication information sharing; receiving a request, from the access and mobility management function, requesting the apparatus to authenticate a user of the apparatus; authenticating the user based on the request; generating user authentication data; and transmitting the user authentication data to the access and mobility management function.

According to a third aspect there is provided an apparatus comprising: means for receiving, from an access and mobility management function, a registration message indicating whether a user equipment supports user authentication information sharing; means for receiving, from at least one application function; at least one network function; or at least one operator and maintenance instance, either a request to invoke user authentication at the user equipment, or a request for user authentication data; means for determining whether the user equipment supports user authentication information sharing; when the user equipment does support user authentication information sharing, means for transmitting a request, to the user equipment via the access and mobility management function, requesting authentication of the user at the user equipment; and means for receiving user authentication data from the user equipment via the access and mobility management function.

According to some examples, the apparatus further comprises means for receiving and storing a username and at least one of a profile identification and PIN identification of each user of the user equipment.

According to some examples, the apparatus comprises means for transmitting a request message to the access and mobility management function prompting the user equipment to authenticate the user.

According to some examples, the user authentication data may comprise at least one of: authentication type; authentication result; profile identification; PIN identification.

According to some examples, the apparatus comprises means for updating the user authentication data and transmitting the updated user authentication data to at least one of the at least one application function; at least one network function; or at least one operator and maintenance instance.

According to some examples, the updated user authentication data comprises at least one of: authentication type; authentication result, a timestamp; a username; an indication indicating whether multiple PINs are supported by the user equipment.

According to a fourth aspect there is provided an apparatus comprising at least one processor; and at least one memory storing instructions that, when executed by the at least one processor, cause the apparatus at least to perform: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to a fifth aspect there is provided an apparatus comprising: means for receiving, from a user equipment, a registration message indicating whether the user equipment supports user authentication information sharing; means for receiving, from a unified data management node, a request message prompting the user equipment to authenticate the user; means for receiving, from the user equipment, user authentication data; and means for transmitting user authentication data to the unified data management node.

According to some examples, the user authentication data comprises at least one of: authentication type; authentication result; profile identification; PIN identification.

According to a sixth aspect there is provided an apparatus comprising at least one processor; and at least one memory storing instructions that, when executed by the at least one processor, cause the apparatus at least to perform: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to a seventh aspect there is provided an apparatus comprising: means for transmitting a request, to a unified data management node, either requesting to invoke user authentication at a user equipment, or requesting user authentication data; and means for receiving user authentication data from the unified data management node.

According to a eighth aspect there is provided an apparatus comprising at least one processor; and at least one memory storing instructions that, when executed by the at least one processor, cause the apparatus at least to perform: transmitting a request, to a unified data management node, either requesting to invoke user authentication at a user equipment, or requesting user authentication data; and receiving user authentication data from the unified data management node.

According to a ninth aspect there is provided a method comprising: transmitting a registration message, to an access and mobility management function, indicating whether a user equipment supports user authentication information sharing; receiving a request, from the access and mobility management function, requesting the user equipment to authenticate a user of the user equipment; authenticating the user based on the request; generating user authentication data; and transmitting the user authentication data to the access and mobility management function.

According to some examples, the method comprises enabling the user to register identification information in the user equipment, for each user of the user equipment.

According to some examples, the method comprises assigning a username and at least one of a profile identification and a PIN identification to the identification information of each user.

According to some examples, the method comprises transmitting the username and at least one of the profile identification and PIN identification for each user of the user equipment to a unified data management node, via the access and mobility management function.

According to some examples, the method comprises authenticating the user by prompting the user to provide the user's identification information.

According to some examples, the identification information comprises at least one of: face biometric information; finger recognition information; PIN information.

According to some examples, the user authentication data comprises at least one of: authentication type; authentication result; profile identification; PIN identification.

According to some examples, the method comprises transmitting user authentication data periodically.

According to a tenth aspect there is provided a method comprising: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to some examples, the method comprises receiving and storing a username and at least one of a profile identification and PIN identification of each user of the user equipment.

According to some examples, the method comprises transmitting a request message to the access and mobility management function prompting the user equipment to authenticate the user.

According to some examples, the user authentication data may comprise at least one of: authentication type; authentication result; profile identification; PIN identification.

According to some examples, the method comprises updating the user authentication data and transmitting the updated user authentication data to at least one of the at least one application function; at least one network function; or at least one operator and maintenance instance.

According to some examples, the updated user authentication data comprises at least one of: authentication type; authentication result, a timestamp; a username; an indication indicating whether multiple PINs are supported by the user equipment.

According to an eleventh aspect there is provided a method comprising: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to some examples, the user authentication data comprises at least one of: authentication type; authentication result; profile identification; PIN identification.

According to a twelfth aspect there is provided a method comprising: transmitting a request, to a unified data management node, either requesting to invoke user authentication at a user equipment or requesting user authentication data; and receiving user authentication data from the unified data management node.

According to a thirteenth aspect there is provided a computer program comprising instructions for causing an apparatus to perform at least the following: transmitting a registration message to an access and mobility management function, indicating whether the apparatus supports user authentication information sharing; receiving a request, from the access and mobility management function, requesting the apparatus to authenticate a user of the apparatus; authenticating the user based on the request; generating user authentication data; and transmitting the user authentication data to the access and mobility management function.

According to some examples, the computer program comprises instructions for causing the apparatus to perform enabling the user to register identification information in the user equipment, for each user of the user equipment.

According to some examples, the computer program comprises instructions for causing the apparatus to perform assigning a username and at least one of a profile identification and a PIN identification to the identification information of each user.

According to some examples, the computer program comprises instructions for causing the apparatus to perform transmitting the username and at least one of the profile identification and PIN identification for each user of the user equipment to a unified data management node, via the access and mobility management function.

According to some examples, the computer program comprises instructions for causing the apparatus to perform authenticating the user by prompting the user to provide the user's identification information.

According to some examples, the identification information comprises at least one of: face biometric information; finger recognition information; PIN information.

According to some examples, the user authentication data comprises at least one of: authentication type; authentication result; profile identification; PIN identification.

According to some examples, the computer program comprises instructions for causing the apparatus to perform transmitting user authentication data periodically.

According to a fourteenth aspect there is provided a computer program comprising instructions for causing an apparatus to perform at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to some examples, the computer program comprises instructions for causing the apparatus to perform receiving and storing a username and at least one of a profile identification and PIN identification of each user of the user equipment.

According to some examples, the computer program comprises instructions for causing the apparatus to perform transmitting a request message to the access and mobility management function prompting the user equipment to authenticate the user.

According to some examples, the user authentication data may comprise at least one of: authentication type; authentication result; profile identification; PIN identification.

According to some examples, the computer program comprises instructions for causing the apparatus to perform updating the user authentication data and transmitting the updated user authentication data to at least one of the at least one application function; at least one network function; or at least one operator and maintenance instance.

According to some examples, the updated user authentication data comprises at least one of: authentication type; authentication result, a timestamp; a username; an indication indicating whether multiple PINs are supported by the UE.

According to a fifteenth aspect there is provided a computer program comprising instructions for causing an apparatus to perform at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to some examples, the user authentication data comprises at least one of: authentication type; authentication result; profile identification; PIN identification.

According to a sixteenth aspect there is provided a computer program comprising instructions for causing an apparatus to perform at least the following: transmitting a request, to a unified data management node, either requesting to invoke user authentication at a user equipment, or requesting user authentication data; and receiving user authentication data from the unified data management node.

According to a seventeenth aspect there is provided a computer program comprising instructions stored thereon for performing at least the following: transmitting a registration message to an access and mobility management function, indicating whether a user equipment supports user authentication information sharing; receiving a request, from the access and mobility management function, requesting the user equipment to authenticate a user of the user equipment; authenticating the user based on the request; generating user authentication data; and transmitting the user authentication data to the access and mobility management function.

According to a eighteenth aspect there is provided a computer program comprising instructions stored thereon for performing at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to a nineteenth aspect there is provided a computer program comprising instructions stored thereon for performing at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to a twentieth aspect there is provided a computer program comprising instructions stored thereon for performing at least the following: transmitting a request, to a unified data management node, either requesting to invoke user authentication at a user equipment, or requesting user authentication data; and receiving user authentication data from the unified data management node.

According to an twenty-first aspect there is provided a non-transitory computer readable medium comprising program instructions that, when executed by an apparatus, cause the apparatus to perform at least the following: transmitting a registration message to an access and mobility management function, indicating whether the apparatus supports user authentication information sharing; receiving a request, from the access and mobility management function, requesting the apparatus to authenticate a user of the apparatus; authenticating the user based on the request; generating user authentication data; and transmitting the user authentication data to the access and mobility management function.

According to an twenty-second aspect there is provided a non-transitory computer readable medium comprising program instructions that, when executed by an apparatus, cause the apparatus to perform at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to an twenty-third aspect there is provided a non-transitory computer readable medium comprising program instructions that, when executed by an apparatus, cause the apparatus to perform at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to an twenty-fourth aspect there is provided a non-transitory computer readable medium comprising program instructions that, when executed by an apparatus, cause the apparatus to perform at least the following: transmitting a request, to a unified data management node, either requesting to invoke user authentication at a user equipment, or requesting user authentication data; and receiving user authentication data from the unified data management node.

According to a twenty-fifth aspect there is provided a non-transitory computer readable medium comprising program instructions stored thereon for performing at least the following: transmitting a registration message to an access and mobility management function, indicating whether a user equipment supports user authentication information sharing; receiving a request, from the access and mobility management function, requesting the user equipment to authenticate a user of the user equipment; authenticating the user based on the request; generating user authentication data; and transmitting the user authentication data to the access and mobility management function.

According to a twenty-sixth aspect there is provided a non-transitory computer readable medium comprising program instructions stored thereon for performing at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to a twenty-seventh aspect there is provided a non-transitory computer readable medium comprising program instructions stored thereon for performing at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to a twenty-eighth aspect there is provided a non-transitory computer readable medium comprising program instructions stored thereon for performing at least the following: transmitting a request, to a unified data management node, either requesting to invoke user authentication at a user equipment, or requesting user authentication data; and receiving user authentication data from the unified data management node.

According to an twenty-ninth aspect there is provided a computer readable medium comprising program instructions that, when executed by a master node apparatus, cause the apparatus to perform at least the following: transmitting a registration message to an access and mobility management function, indicating whether the apparatus supports user authentication information sharing; receiving a request, from the access and mobility management function, requesting the apparatus to authenticate a user of the apparatus; authenticating the user based on the request; generating user authentication data; and transmitting the user authentication data to the access and mobility management function.

According to an thirtieth aspect there is provided a computer readable medium comprising program instructions that, when executed by a master node apparatus, cause the apparatus to perform at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to an thirty-first aspect there is provided a computer readable medium comprising program instructions that, when executed by a master node apparatus, cause the apparatus to perform at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to an thirty-second aspect there is provided a computer readable medium comprising program instructions that, when executed by a master node apparatus, cause the apparatus to perform at least the following: transmitting a request, to a unified data management node, either requesting to invoke user authentication at a user equipment, or requesting user authentication data; and receiving user authentication data from the unified data management node.

According to a thirty-third aspect there is provided a computer readable medium comprising program instructions stored thereon for performing at least the following: transmitting a registration message to an access and mobility management function, indicating whether a user equipment supports user authentication information sharing; receiving a request, from the access and mobility management function, requesting the user equipment to authenticate a user of the user equipment; authenticating the user based on the request; generating user authentication data; and transmitting the user authentication data to the access and mobility management function.

According to a thirty-fourth aspect there is provided a computer readable medium comprising program instructions stored thereon for performing at least the following: receiving, from an access and mobility management function, a registration message indicating whether a user equipment supports user authentication information sharing; receiving, from at least one application function; at least one network function; or at least one operator and maintenance instance, either a request to invoke user authentication at the user equipment, or a request for user authentication data; determining whether the user equipment supports user authentication information sharing; when the user equipment does support user authentication information sharing, transmitting a request, to the user equipment via the access and mobility management function, requesting authentication of the user at the user equipment; and receiving user authentication data from the user equipment via the access and mobility management function.

According to a thirty-fifth aspect there is provided a computer readable medium comprising program instructions stored thereon for performing at least the following: receiving, from a user equipment, a registration message indicating whether the user equipment supports user authentication information sharing; receiving, from a unified data management node, a request message prompting the user equipment to authenticate the user; receiving, from the user equipment, user authentication data; and transmitting user authentication data to the unified data management node.

According to a thirty-sixth aspect there is provided a computer readable medium comprising program instructions stored thereon for performing at least the following: transmitting a request, to a unified data management node, either requesting to invoke user authentication at a user equipment, or requesting user authentication data; and receiving user authentication data from the unified data management node.

### DESCRIPTION OF FIGURES

Embodiments will now be described, by way of example only, with reference to the accompanying Figures in which:

FIG. 1 shows a representation of a network system according to some example embodiments;

FIG. 2 is a signalling diagram according to an example embodiment.

FIG. 3 is a signalling diagram according to an example embodiment.

FIG. 4 shows a schematic representation of a control apparatus according to some example embodiments;

FIG. 5 shows a schematic representation of an apparatus according to some example embodiments;

FIG. 6 is a flow chart of a method according to an example embodiment;

FIG. 7 is a flow chart of a method according to an example embodiment;

FIG. 8 is a flow chart of a method according to an example embodiment;

FIG. 9 is a flow chart of a method according to an example embodiment;

FIG. 10 shows a schematic representation of a non-volatile memory medium storing instructions which when executed by a processor allow a processor to perform one or more of the steps of the methods of some embodiments.

### DETAILED DESCRIPTION

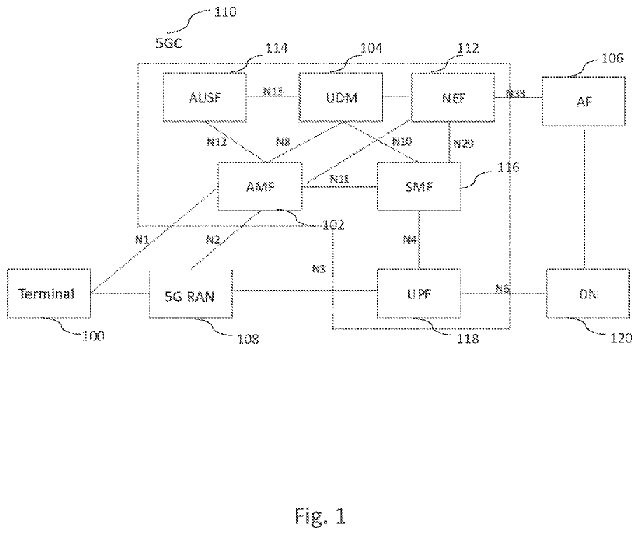

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1 to assist in understanding the technology underlying the described examples.

FIG. 1 shows a schematic representation of a 5G system (5GS), which is provided by way of example of a communication system. The 5GS may comprise a terminal or user equipment (UE) 100, a 5G radio access network (5GRAN) 108 or next generation radio access network (NG-RAN), a 5G core network (5GC) 110, one or more application function (AF) 106 and one or more data networks.

The 5G-RAN may comprise one or more gNodeB (gNB) or one or more gNodeB (gNB) distributed unit functions connected to one or more gNodeB (gNB) centralized unit functions.

The 5GC may comprise the following entities: Network Slice Selection Function (NSSF); Network Exposure Function 112; Network Repository Function (NRF); Policy Control Function (PCF); Unified Data Management (UDM) 104; Application Function (AF) 106; Authentication Server Function (AUSF) 114; an Access and Mobility Management Function (AMF) 104; Session Management Function (SMF) 116; User Plane Function 118; and Data Network 120. FIG. 1 also shows the various interfaces (N1, N2 etc.) that may be implemented between the various elements of the system.

It is noted that whilst some embodiments are described in relation to 5G networks, similar principles can be applied in relation to other networks and communication systems such as 5G-Advanced networks or 6G networks.

SA1 Metaverse TR 22856 describes that subject to regulatory requirements, operator policies and user consent, a 5G system may be able to support mechanisms to expose to a trusted third party (e.g., a conference focus) the result of a UE authenticating a user. For example, a conference focus may be a term used in 3GPP for a conference server. How a UE authenticates a user's identify at the terminal equipment (for example, using biometrics) is out of 3GPP scope.

There are various ways a UE may authenticate a user. For example, some UEs (for example mobile phones) provide face biometrics or finger biometrics through which a user is authenticated. However, there are also many UEs that do not support authenticating a user via biometrics, for example, a limited feature phone where only a Personal Identification Number (PIN) is used for user authentication. In other UEs, a PIN may not be supported.

A single UE can be used by multiple users (e.g., a whole family). For example, a single UE may be used by multiple users to connect to a communication system, or more particularly to connect to the internet or metaverse. In such cases, the UE may want to share, with the metaverse or a third-party, information about how the UE is authenticating the user. The UE may also want to share the result of the user authentication. However, currently, a result of a UE authenticating a user is not shared with 5GC. Therefore, 5GC is not able to share this information with the metaverse.

The present disclosure proposes a framework where 5GC provides a service to expose user authentication data at the UE. For example, 5GC may provide a service to expose a user authentication status at the UE. For example, the 5GC may expose the result of the UE authenticating the user. This can be applicable in any industry. For example, embodiments may be applicable in industrial internet of things (IIoT) settings. Embodiments may also be applicable in banking or in gaming.

Some embodiments disclosed herein provide a framework for an Application Function (AF) to request 5GC to collect user authentication data from the UE. Some embodiments disclosed provide an exposure service at 5GC which indicates to a service user authentication data at the UE. Some embodiments disclosed provide changes to the UE to enable these frameworks to work.

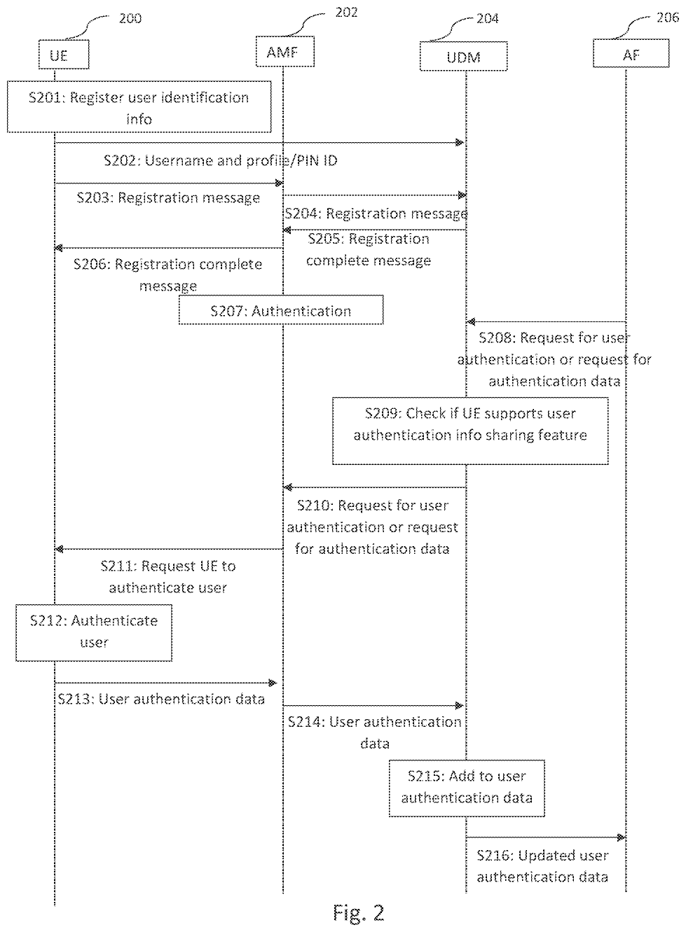

FIG. 2 shows an example for single user authentication. Single user authentication may occur when a user equipment 200 (e.g., a mobile phone) is being used by a single user.

In this example, at S201, an owner or user of the UE 200 registers and/or stores identification information in the UE 200 for the user of the UE 200. Identification information may include at least one of biometric information (e.g., face biometric information or finger recognition information); PIN information. The UE 200 may assign a username to the identification information of the user. If biometric information is registered and/or stored in the UE 200, the UE 200 may assign a profile ID to the username and associated biometric information. If the user registers and/or stores PIN information in the UE 200, the UE 300 may assign a PIN ID to the username and associated PIN information. In some examples, 5GC does not store the identification information of the user. Instead, 5GC may store the profile ID and/or PIN ID assigned to the user.

At S202, the UE 200 may transmit the username and associated profile ID and/or PIN ID to the UDM 204, via the AMF 202. The UDM 204 may store this information.

At S203, the UE 200 transmits a registration message to an AMF 202. The registration message may comprise an indication that the UE 200 supports a user authentication information sharing feature. In some examples, if the UE 200 supports the user authentication information sharing feature, the UE 200 will share information of the UE 200 with 5GC. For example, if the UE 200 supports the user authentication information sharing feature, the UE 200 may share user authentication data with 5GC. The AMF 202 may store the registration message. The AMF 202 may store the indication that the UE 200 supports the user authentication information sharing feature.

At S204, the AMF 202 transmits a registration message to a UDM 204. The registration message may be transmitted as a new flag to indicate that the UE 200 supports the user authentication information sharing feature. For example, the registration message transmitted at S202 may be in the form of a Nudm_UECM_Registration message.

At S205, the UDM 204 transmits a registration complete message to the AMF 202.

At S206, the AMF 202 transmits a registration complete message to the UE 200.

At S207, the AMF 202 authenticates the UE 200.

At S208, an AF 206 transmits a request to the UDM 204, requesting the 5GC to invoke user authentication at the UE 200. Alternatively, the AF 206 transmits a request to the UDM 204 requesting the user authentication data of the last stored user authentication data at the UE 200. In some examples, the request may be transmitted to a network function. In some examples, the request may be transmitted to an operator and maintenance instance. The request may be a Nudm_UEAuthorisation_request, in some examples. The Nudm_UEAuthorisation_request may comprise a Generic Public Subscription Identifier (GPSI), in some examples. The AF 206 may be a metaverse AF, in some examples. The AF 206 may be an external AF, in some examples. For example, an external AF may be a third-party AF to the 5GC network. Where the AF 206 is an external AF, the request is transmitted to a Network Exposure Function (NEF) before the UDM 204. The NEF then transmits the request to the UDM 204. The NEF enables an external AF to transmit information to the 5GC.

At S209, the UDM 204 checks whether the UE 200 supports the user authentication information sharing feature. If the UE 200 does support the user authentication information sharing feature, S210 to S216 apply. If the UE 200 does not support the user authentication information sharing feature, the UDM 204 may not request for user authentication at the UE 200.

At S210, the UDM 204 transmits a message or request to the AMF 202 requesting user authentication at the UE 200. Alternatively, the UDM 204 transmits a message or request to the AMF 202 requesting the user authentication data of the last stored user authentication data at the UE 200. In some examples, the request may be a service request message. In some examples, the request may be a notification message.

At S211, the AMF 202 transmits a message to the UE 200 requesting the UE to authenticate the user. In some examples, the message may be an NAS message.

At S212, based on the request received from the AMF 202, the UE 200 authenticates the user. In some examples, the UE 200 asks the user to authenticate itself. For example, the UE 200 asks the user for identification information. Identification information may include at least one of biometric information (e.g., face biometric information or finger recognition information); PIN information. If the identification information provided by the user matches the identification information provided by the user in S201, the UE 200 may authenticate the user. The UE 200 generates user authentication data. In some examples, user authentication data includes at least one of authentication type; authentication result; profile ID; PIN ID. In some examples, the authentication type may be at least one of face biometric; finger recognition; PIN. In some examples, the authentication result may be “success” or “failure”. The profile ID and/or PIN ID is associated with the identification information of the authenticated user.

At S213, the UE 200 transmits the user authentication data to the AMF 202. In some examples, the UE 200 transmits the user authentication data periodically.

At S214, the AMF 202 transmits the user authentication data to the UDM 204.

At S215, the UDM 204 adds additional information to the user authentication data received from the AMF 202. In some examples, the additional information may include at least one of: a timestamp; a username. From S202, the UDM 204 has a username and an associated profile ID and/or PIN ID stored. In some examples, when the UDM 204 receives the profile ID and/or the PIN ID in the authentication data, the UDM 204 selects the username associated with the profile ID and/or PIN ID.

At S216, the UDM 204 transmits the updated user authentication data (i.e., the user authentication data received from the AMF 202 and the additional information the UDM 204 adds) to the AF 206. In some examples, the UDM 204 does not transmit the profile ID and/or PIN ID to the AF 206. Instead, the UDM 204 transmits the username associated with the profile ID and/or PIN ID to the AF 206. The AF 206 may be a metaverse AF, in some examples. The AF 206 may be an external AF, in some examples. In some examples, the UDM 204 may transmit the updated user authentication data to a network function. In some examples, the UDM 204 may transmit the updated user authentication data to an operator and maintenance instance.

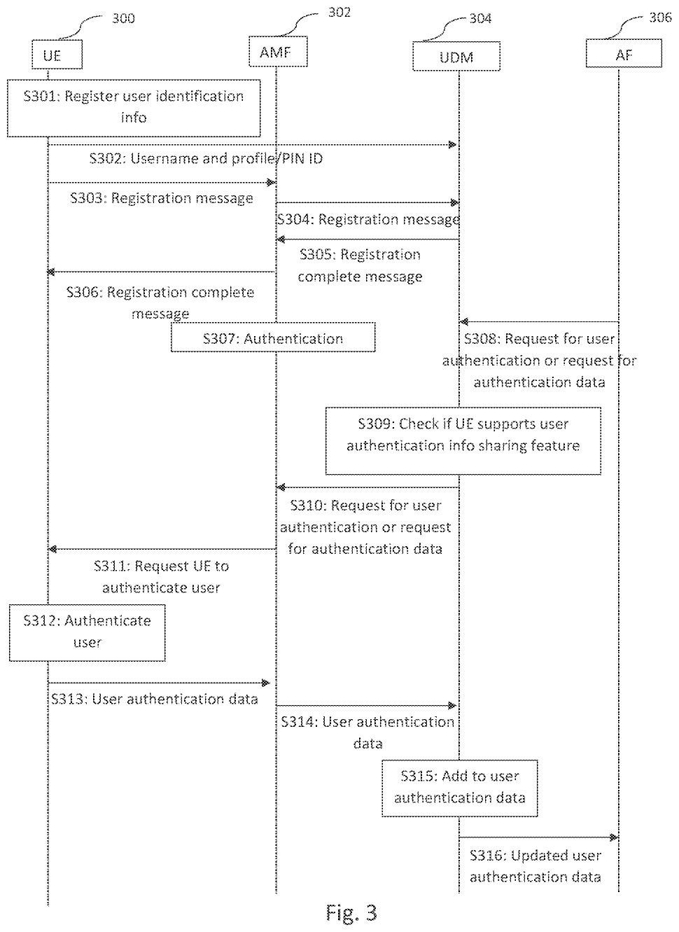

FIG. 3 shows an example for multiple user authentication. Multiple user authentication may occur when a user equipment 300 (e.g., a mobile phone) is being used by or is accessible to multiple users. For example, each of the multiple users may access the UE 300 at different times.

In this example, at S301, an owner or user of the UE 300 registers and/or stores identification information in the UE 300 for each user of the UE 300. Identification information may include at least one of biometric information (e.g., face biometric information or finger recognition information); PIN information. In some examples, storing multiple PINs may not be supported by the UE. In some examples, PIN information may not ensure full user authentication because any user can store any PIN. The UE 300 may assign the identification information of each user to a username. If biometric information is registered and/or stored in the UE 300, the UE 300 may assign a profile ID to each username and associated biometric information. If registering and/or storing multiple PINs is supported by the UE 300 and each user registers and/or stores PIN information in the UE 300, the UE 300 may assign a PIN ID to each username and associated PIN information. For example, the information stored on the UE 300 may be as shown in Table 1, below. In some examples, 5GC does not store the identification information of the user. Instead, 5GC may store the profile ID and/or PIN ID assigned to the user.

TABLE 1
Example information stored on a UE for
a multiple user authentication process

| Username | Profile ID | Identification data |
|---|---|---|
| X | 1 | Face1 |
| Y | 2 | Face2 |

At S302, the UE 300 may transmit the username and associated profile ID and/or PIN ID to the UDM 304, via the AMF 302. The UDM 304 may store this information.

At S303, the UE 300 transmits a registration message to an AMF 302. The registration message may comprise an indication that the UE 300 supports a user authentication information sharing feature. In some examples, if the UE 300 supports the user authentication information sharing feature, the UE 300 will share information of the UE 300 with 5GC. For example, if the UE 300 supports the user authentication information sharing feature, the UE 300 may share user authentication data with 5GC. The AMF 302 may store the registration message. The AMF 302 may store the indication that the UE 300 supports the user authentication information sharing feature.

At S304, the AMF 302 transmits a registration message to a UDM 304. The registration message may be transmitted as a new flag to indicate that the UE 300 supports the user authentication information sharing feature. For example, the registration message transmitted at S303 may be in the form of a Nudm_UECM_Registration message.

At S305, the UDM 304 transmits a registration complete message to the AMF 302.

At S306, the AMF 302 transmits a registration complete message to the UE 300.

At S307, the AMF 302 authorises the user authentication information sharing feature.

At S308, an AF 306 transmits a request to the UDM 304, requesting the 5GC to invoke user authentication at the UE 300. Alternatively, the AF 306 transmits a request to the UDM 304 requesting the user authentication data of the last stored user authentication data at the UE 300. In some examples, the request may be transmitted to a network function. In some examples, the request may be transmitted to an operator and maintenance instance. The request may be a Nudm_UEAuthorisation_request, in some examples. The Nudm_UEAuthorisation_request may comprise a Generic Public Subscription Identifier (GPSI), in some examples. The AF 306 may be a metaverse AF, in some examples. The AF 306 may be an external AF, in some examples. For example, an external AF may be a third-party AF to the 5GC network. Where the AF 306 is an external AF, the request may be transmitted to a Network Exposure Function (NEF) before the UDM 304. The NEF then transmits the request to the UDM 304. The NEF enables an external AF to transmit information to the 5GC.

At S309, the UDM 304 checks whether the UE 300 supports the user authentication information sharing feature. If the UE 300 does support the user authentication information sharing feature, S310 to S316 apply. If the UE 300 does not support the user authentication information sharing feature, the UDM 304 may not request for user authentication at the UE 200.

At S310, the UDM 304 transmits a message or request to the AMF 302 requesting user authentication at the UE 300. Alternatively, the UDM 304 transmits a message or request to the AMF 302 requesting the user authentication data of the last stored user authentication data at the UE 300. In some examples, the request may be a service request message. In some examples, the request may be a notification message.

At S311, the AMF 302 transmits a message to the UE 300 requesting the UE 300 to authenticate the user. In some examples, the message may be an NAS message.

At S312, based on the request received from the AMF 302, the UE 300 authenticates the user. In some examples, the UE 300 asks the user to authenticate itself. For example, the UE 300 asks the user for identification information. In some examples, the identification information may be at least one of biometric information (e.g., face biometric information or finger recognition information); PIN information. If the identification information provided by the user matches the identification information provided by the user in S301, the UE 300 may authenticate the user. The UE 300 generates user authentication data. In some examples, user authentication data includes at least one of authentication type; authentication result; profile ID; PIN ID. In some examples, the authentication type may be at least one of: face biometric; finger recognition; PIN. In some examples, the authentication result may be success or failure. The profile ID and/or PIN ID is associated with the identification information of the authenticated user.

At S313, the UE 300 transmits the user authentication data to the AMF 302. In some examples, the UE 300 transmits the user authentication data periodically. At S314, the AMF 302 transmits the user authentication data to the UDM 304.

At S315, the UDM 304 adds additional information to the user authentication data received from the AMF 302. In some examples, the additional information may include at least one of a timestamp; a username. From S302, the UDM 304 has a username and an associated profile ID and/or PIN ID stored. In some examples, when the UDM 304 receives the profile ID and/or the PIN ID in the authentication data, the UDM 304 selects the username associated with the profile ID and/or PIN ID. If storing multiple PINs is not supported by the UE 300, the UDM 304 may add information to the authentication data indicating that multiple PINs are not supported by the UE 300.

At S316, the UDM 304 transmits the updated user authentication data (i.e., the user authentication data received from the AMF 302 and the additional information the UDM 304 adds) to the AF 306. In some examples, the UDM 304 does not transmit the profile ID and/or PIN ID to the AF 306. Instead, the UDM 304 transmits the username associated with the profile ID and/or PIN ID to the AF 306. The AF 306 may be a metaverse AF, in some examples. The AF 306 may be an external AF, in some examples. In some examples, the UDM 304 may transmit the updated user authentication data to a network function. In some examples, the UDM 304 may transmit the updated user authentication data to an operator and maintenance instance.

In 5G/5GC, operators can expose new capabilities through Application Program Interfaces (APIs). In some examples, the UDM may provide a service API. For example, the UDM may provide authentication data of a UE via service API. In some examples, the AF can request to provide the last stored user authentication data of the UE. In some examples, the AF may send this request to the UDM. In this case, the UDM may provide the last stored user authentication data of the UE to a AF via service API without asking the UE.

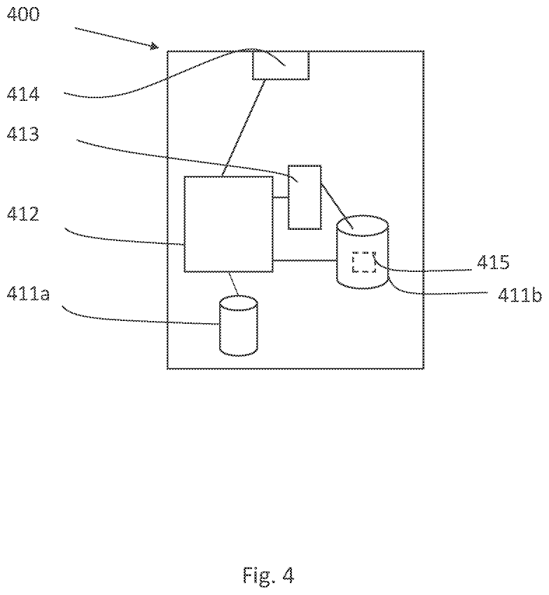

FIG. 4 illustrates an example of a control apparatus 400 for controlling a function of the 5GRAN or the 5GC as illustrated on FIG. 1. The control apparatus may comprise at least one random access memory (RAM) 411a, at least on read only memory (ROM) 411b, at least one processor 412, 413 and an input/output interface 414. The at least one processor 412, 413 may be coupled to the RAM 411a and the ROM 411b. The at least one processor 412, 413 may be configured to execute an appropriate software code 415. The software code 415 may for example allow to perform one or more steps to perform one or more of the present aspects. The software code 415 may be stored in the ROM 411b. The control apparatus 400 may be interconnected with another control apparatus 400 controlling another function of the 5GRAN or the 5GC. In some embodiments, each function of the 5GRAN or the 5GC comprises a control apparatus 400. In alternative embodiments, two or more functions of the 5GRAN or the 5GC may share a control apparatus.

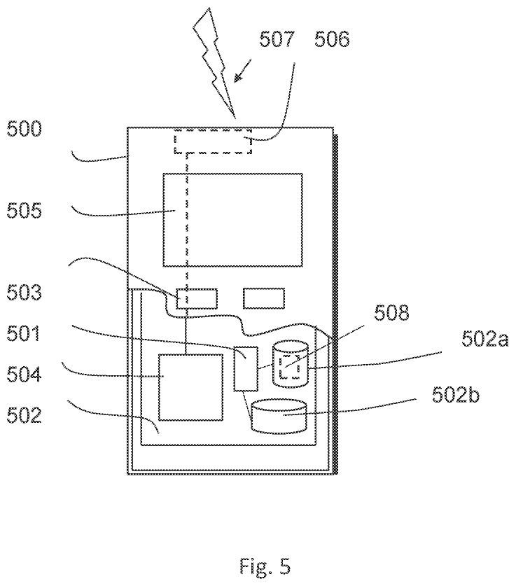

FIG. 5 illustrates an example of a terminal 500, such as the terminal illustrated on FIG. 1. The terminal 500 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 500 may provide, for example, communication of data for carrying communications. The communications may be one or more of voice, electronic mail (email), text message, multimedia, data, machine data and so on.

The terminal 500 may be provided with at least one processor 501, at least one memory ROM 502a, at least one RAM 502b and other possible components 503 for use in software and hardware aided execution of tasks it is designed to perform, including control of access to and communications with access systems and other communication devices. The at least one processor 501 is coupled to the RAM 502b and the ROM 502a. The at least one processor 501 may be configured to execute an appropriate software code 508. The software code 508 may for example allow to perform one or more of the present aspects. The software code 508 may be stored in the ROM 502a.

The processor, storage and other relevant control apparatus can be provided on an appropriate circuit board and/or in chipsets. This feature is denoted by reference 504. The device may optionally have a user interface such as key pad 505, touch sensitive screen or pad, combinations thereof or the like. Optionally one or more of a display, a speaker and a microphone may be provided depending on the type of the device.

The terminal 500 may receive signals over an air or radio interface 507 via appropriate apparatus for receiving and may transmit signals via appropriate apparatus for transmitting radio signals. In FIG. 5 transceiver apparatus is designated schematically by block 506. The transceiver apparatus 506 may be provided for example by means of a radio part and associated antenna arrangement. The antenna arrangement may be arranged internally or externally to the mobile device.

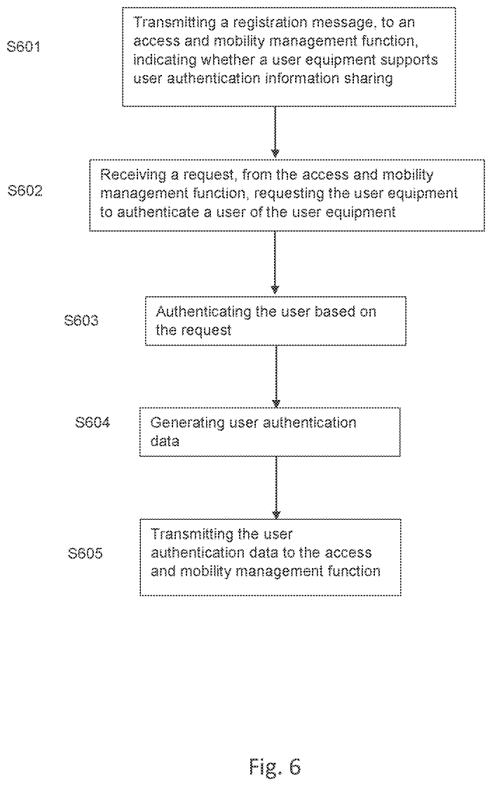

FIG. 6 is a flow chart of a method according to an example. The flow chart of FIG. 6 is viewed from the perspective of an apparatus. For example, the apparatus may comprise a user equipment.

As shown at S601, the method comprises transmitting a registration message, to an access and mobility management function, indicating whether a user equipment supports user authentication information sharing.

At S602, the method comprises receiving a request, from the access and mobility management function, requesting the user equipment to authenticate a user of the user equipment.

At S603, the method comprises authenticating the user based on the request.

At S604, the method comprises generating user authentication data.

At S605, the method comprises transmitting the user authentication data to the access and mobility management function.

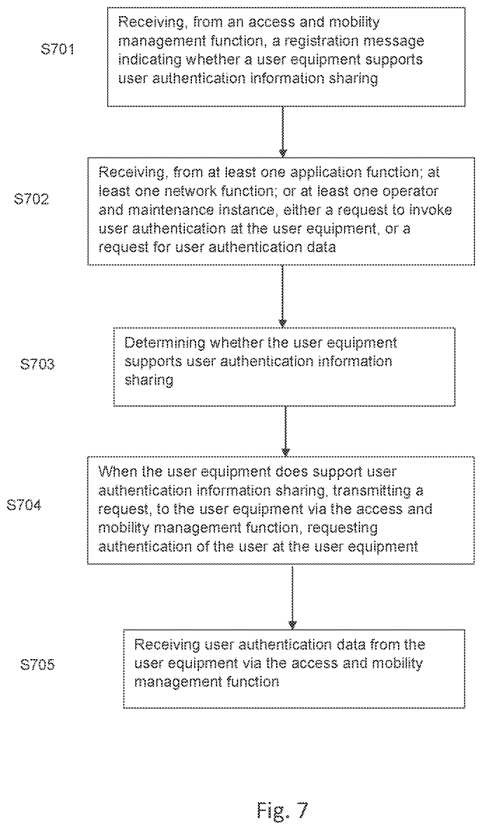

FIG. 7 is a flow chart of a method according to an example. The flow chart of FIG. 7 is viewed from the perspective of an apparatus. For example, the apparatus may comprise a unified data management node.

As shown at S701, the method comprises receiving, from an access and mobility management function, a registration message indicating whether a user equipment supports user authentication information sharing.

At S702, the method comprises receiving, from at least one application function; at least one network function; or at least one operator and maintenance instance, either a request to invoke user authentication at the user equipment, or a request for user authentication data.

At S703, the method comprises determining whether the user equipment supports user authentication information sharing.

At S704, when the user equipment does support user authentication information sharing, the method comprises transmitting a request, to the user equipment via the access and mobility management function, requesting authentication of the user at the user equipment; and

At S705, the method comprises receiving user authentication data from the user equipment via the access and mobility management function.

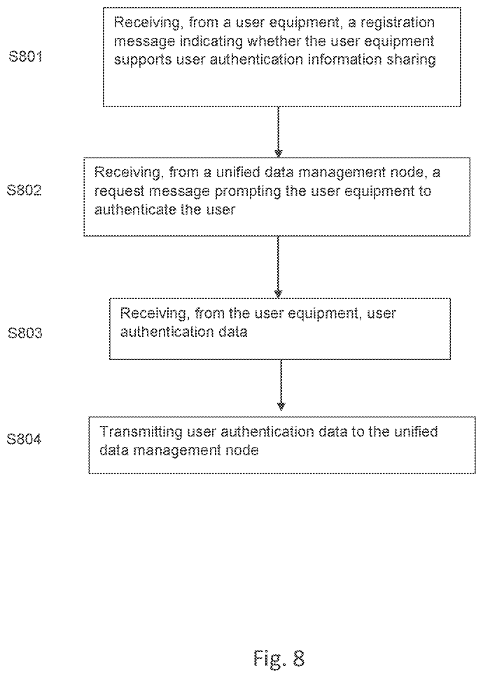

FIG. 8 is a flow chart of a method according to an example. The flow chart of FIG. 8 is viewed from the perspective of an apparatus. For example, the apparatus may comprise an Access and Mobility Management Function.

As shown at S801, the method comprises receiving, from a user equipment, a registration message indicating whether the user equipment supports user authentication information sharing.

At S802, the method comprises receiving, from a unified data management node, a request message prompting the user equipment to authenticate the user.

At S803, the method comprises receiving, from the user equipment, user authentication data.

At S804, the method comprises transmitting user authentication data to the unified data management node.

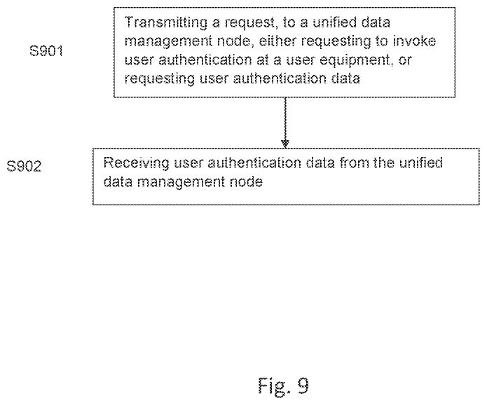

FIG. 9 is a flow chart of a method according to an example. The flow chart of FIG. 9 is viewed from the perspective of an apparatus. For example, the apparatus may comprise at least one of: at least one application function; at least one network function; at least one operator and maintenance instance.

As shown at S901, the method comprises transmitting a request, to a unified data management node, either requesting to invoke user authentication at a user equipment, or requesting user authentication data.

At S902, the method comprises receiving user authentication data from the unified data management node.

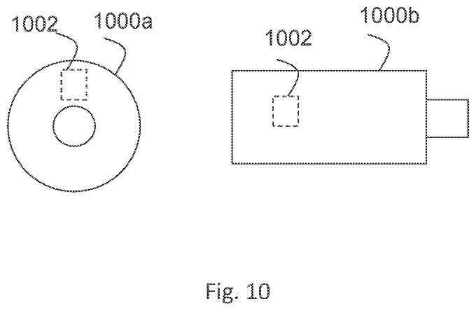

FIG. 10 shows a schematic representation of non-volatile memory media 1000a (e.g. computer disc (CD) or digital versatile disc (DVD)) and 1000b (e.g. universal serial bus (USB) memory stick) storing instructions and/or parameters 1002 which when executed by a processor allow the processor to perform one or more of the steps of the method of FIG. 6, 7, 8 or 9.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor, and at least one memory storing instructions that, when executed by the at least one processor, cause the apparatus at least to:
transmit a registration message, to an access and mobility management function, indicating whether the apparatus supports user authentication information sharing;
receive a request, from the access and mobility management function, requesting the apparatus to authenticate a user of the apparatus;
authenticate the user based on the request;
generate user authentication data; and
transmit the user authentication data to the access and mobility management function.

2. The apparatus of claim 1, further caused to enable the user to register identification information in the apparatus, for each user of the apparatus.

3. The apparatus of claim 2, further caused to assign a username and at least one of a profile identification and a personal identification number identification to the identification information of each user.

4. The apparatus of claim 3, further caused to transmit the username and at least one of the profile identification and personal identification number identification for each user of the apparatus to a unified data management node, via the access and mobility management function.

5. The apparatus of claim 1, further caused to authenticate the user by prompting the user to provide the user's identification information.

6. The apparatus of claim 2, wherein the identification information comprises at least one of: face biometric information; finger recognition information; personal identification number information.

7. The apparatus of claim 1, wherein the user authentication data comprises at least one of: authentication type; authentication result; profile identification; personal identification number identification.

8. The apparatus of claim 1, wherein the apparatus transmits user authentication data periodically.

9. An apparatus comprising at least one processor, and at least one memory storing instructions that, when executed by the at least one processor, cause the apparatus at least to:
receive, from an access and mobility management function, a registration message indicating whether a user equipment supports user authentication information sharing;
receive, from at least one application function; at least one network function; or at least one operator and maintenance instance, either a request to invoke user authentication at the user equipment, or a request for user authentication data;
determine whether the user equipment supports user authentication information sharing;
when the user equipment does support user authentication information sharing, transmit a request, to the user equipment via the access and mobility management function, requesting authentication of the user at the user equipment; and
receive user authentication data from the user equipment via the access and mobility management function.

10. The apparatus of claim 9, further caused to receive and store a username and at least one of a profile identification and personal identification number identification of each user of the user equipment.

11. The apparatus of claim 9, further caused to transmit a request message to the access and mobility management function prompting the user equipment to authenticate the user.

12. The apparatus of claim 9, wherein the user authentication data may comprise at least one of: authentication type; authentication result; profile identification; personal identification number identification.

13. The apparatus of claim 9, further caused to update the user authentication data and transmit the updated user authentication data to at least one of the at least one application function; at least one network function; or at least one operator and maintenance instance.

14. The apparatus of claim 13, wherein the updated user authentication data comprises at least one of: authentication type; authentication result, a timestamp; a username; an indication indicating whether multiple personal identification numbers are supported by the user equipment.

15. An apparatus comprising at least one processor, and at least one memory storing instructions that, when executed by the at least one processor, cause the apparatus at least to:
receive, from a user equipment, a registration message indicating whether the user equipment supports user authentication information sharing;
receive, from a unified data management node, a request message prompting the user equipment to authenticate the user;
receive, from the user equipment, user authentication data; and
transmit user authentication data to the unified data management node.

16. The apparatus of claim 15, wherein the user authentication data comprises at least one of: authentication type; authentication result; profile identification; personal identification number identification.
